(19) United States
(12) Patent Application Publication
(10) Pub. No.: US 2001/0023817 A1
(43) Pub. Date: Sep. 27, 2001

(54) Switch apparatus

(75) Inventors: Takao Ohgimoto, Aichi (JP); Noriyasu Sakai, Aichi (JP)

Correspondence Address: MORGAN, LEWIS & BOCKIUS, 1800 M STREET NW, WASHINGTON, DC, 20036-5869, US

(73) Assignee: KABUSHIKI KAISHA TOKAI RIKA DENKI SEISAKUSHO

(21) Appl. No.: 09/793,568

(22) Filed: Feb. 27, 2001

(30) Foreign Application Priority Data
Mar. 23, 2000 (JP) P.2000-082084

(51) Int. Cl. H01H 9/06

(52) U.S. Cl. 200/11 DA; 200/61.88

(57) ABSTRACT

Auxiliary fixed contacts electrically connected to a fixed contact of other lane are provided in blank areas which resides in shift positions to which a moving contact member moved along with a shift lever is positioned and in which the fixed contact corresponding to the lane of first to fifth lanes is absent. Since the auxiliary fixed contacts are provided in the portions of the blank areas in which the contact parts have passed over conventionally, contact parts will also make contact with the auxiliary fixed contacts. As a result of this, for example, in a “P” position, in case that chattering occurs between a second fixed contact and the contact part, a predetermined signal can be obtained as long as the auxiliary fixed contact makes contact with the contact part.

### BACKGROUND OF THE INVENTION

1. Technical Field of the Invention

The present invention relates to a switch apparatus with a structure in which contact parts which a moving contact member has make a connection or disconnection to fixed contacts present on corresponding lanes with a movement of the moving contact member.

2. Related Art

For example, in an automobile, there is the switch apparatus with a structure for detecting shift positions of a shift lever in an automatic transmission as shown in FIG. 5. Incidentally, as shown in FIG. 5, fixed contacts of a substrate 1 are expanded and shown in a model manner for convenience in understanding a principle.

In FIG. 5, on the substrate 1 made of a printed substrate, in this case, five lanes 2a to 2e are set and five fixed contacts 3a to 3e are provided in correspondence with these five lanes 2a to 2e. It is constructed so that the lowest fixed contact 3a of the five fixed contacts 3a to 3e in FIG. 5 is a common fixed contact for power source and the other four fixed contacts 3b to 3e are used for signal output to output a signal to a CPU for automobile control. Then, the five fixed contacts 3a to 3e are arranged in a pattern as shown in FIG. 5 in order to take out a signal for detecting shift positions (P, R, N, D, 3, 2, L) of a shift lever (not shown). In this case, in each the lane 2a to 2e, an area in which the corresponding fixed contacts 3a to 3e are absent is set to a blank area 4. Also, the second and fourth lowest fixed contacts 3b and 3d of the five fixed contacts 3a to 3e are separated into plural portions on the lanes 2b and 2d, but each the separated fixed contact 3b and 3d is electrically connected each other through a narrow alternative route 5.

On the other hand, a moving contact member 6 moved along with the shift lever has integrally five contact parts 6a to 6e made of a leaf spring and is moved among the shift positions (P, R, N, D, 3, 2, L) acting as a working position. The five contact parts 6a to 6e slide along the respectively corresponding lanes 2a to 2e and make a connection or disconnection to the fixed contacts 3a to 3e present on the corresponding lanes 2a to 2e with the slide. Portions in which the contact parts 6a to 6e make contact with the fixed contacts 3a to 3e are indicated by black circles. Each of the five contact parts 6a to 6e is elastically urged to the side of the substrate 1, respectively.

In the structure described above, when the moving contact member 6 is moved along with the shift lever in the direction of arrow A in the drawing (the right or left direction), each the contact part 6a to 6e slides along the corresponding lanes 2a to 2e and makes a connection or disconnection to the fixed contacts 3a to 3e on the corresponding lanes 2a to 2e with the slide. Based on this, a detection signal is outputted from the fixed contacts 3b to 3e. In the CPU side, based on this detection signal, the shift positions of the shift lever are detected.

The switch apparatus with the related structure has the following disadvantage. That is, for example, in case that dust or abrasion powder intervenes between the contact parts and the fixed contacts while the contact parts 6a to 6e of the moving contact member 6 slide on the corresponding lanes 2a to 2e, there is a possibility that chattering occurs and the necessary signal breaks, and it is considered that reliability reduces due to this cause.

### SUMMARY OF THE INVENTION

The invention is implemented in view of the circumstances described above, and an object of the invention is to provide a switch apparatus capable of improving reliability.

In order to achieve the object, the invention of claim 1 is characterized by a switch apparatus comprising plural fixed contacts provided in correspondence with plural lanes on a substrate, and a moving contact member which is slid along the plural lanes and has plural contact parts electrically connected and is positioned to plural working positions in a movement direction, and in the switch apparatus with a structure in which each the contact part makes a connection or disconnection to the fixed contacts present on the corresponding lanes with a movement of the moving contact member, it is constructed so that an auxiliary fixed contact electrically connected to the fixed contact of other lane is provided in a blank area which resides in the working positions to which the moving contact member is positioned and in which the fixed contact corresponding to the lane of the plural lanes is absent.

Depending on the working positions to which the moving contact member is positioned, there is a blank area in which the fixed contact corresponding to the lane of the plural lanes of the substrate is unnecessary. Conventionally, in the blank area, the fixed contact was not provided and also the contact part of the moving contact member only passed over.

On the contrary, in the invention of claim 1, it is constructed so that the auxiliary fixed contact electrically connected to the fixed contact of other lane is provided in the blank area in which the fixed contact corresponding to the lane of the plural lanes of the substrate is absent. Thereby, the auxiliary fixed contact is provided in the portion in which the contact part has passed over conventionally, so that the contact part will make contact with the auxiliary fixed contact. As a result of this, in case that chattering occurs between the fixed contact connected to the auxiliary fixed contact and the contact part corresponding to this, a predetermined signal can be obtained as long as the auxiliary fixed contact makes contact with the contact part corresponding to this. Therefore, in the fixed contact to which the auxiliary fixed contact is connected, contact portions with the contact part increase, so that reliability can be improved by that increase.

### BRIEF DESCRIPTION OF THE DRAWINGS

FIG. 1 shows one embodiment of the present invention and is a front view of a main part expanding and showing fixed contacts and auxiliary fixed contacts of a substrate in a model manner.

FIG. 2 is a front view of a stator.

FIG. 3 is a front view of the substrate.

FIG. 4 is a diagram showing connection circuits of shift positions and between each the shift position.

FIG. 5 is a view equivalent to FIG. 1 showing a related art.

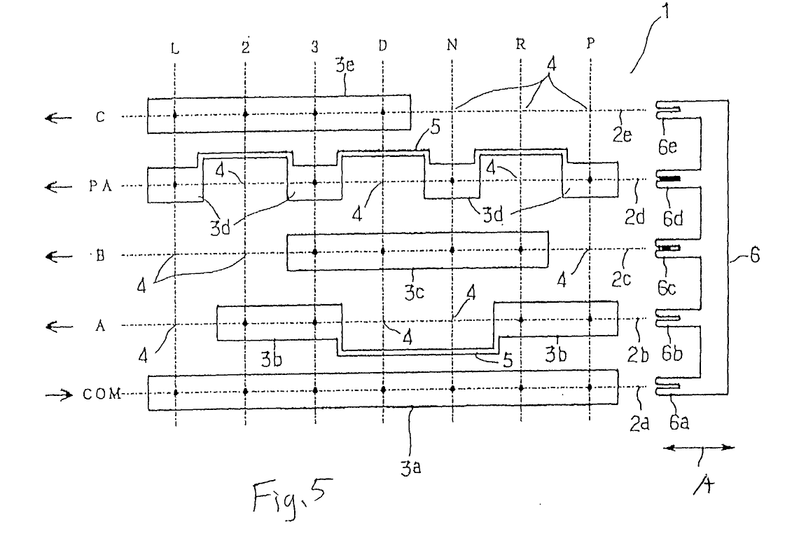

### DESCRIPTION OF PREFERRED EMBODIMENT

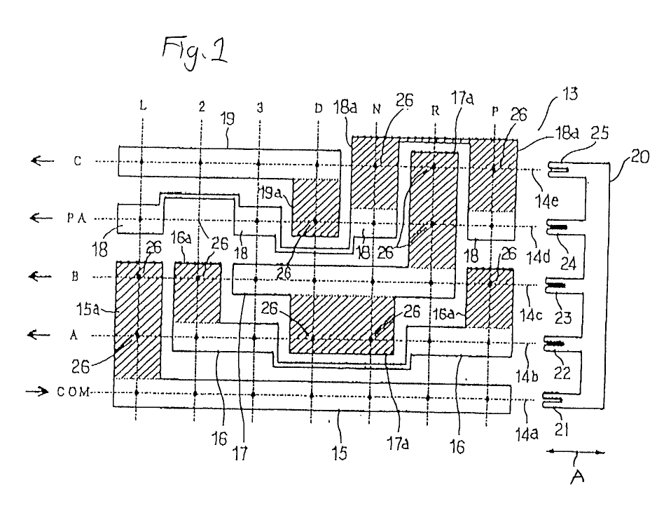

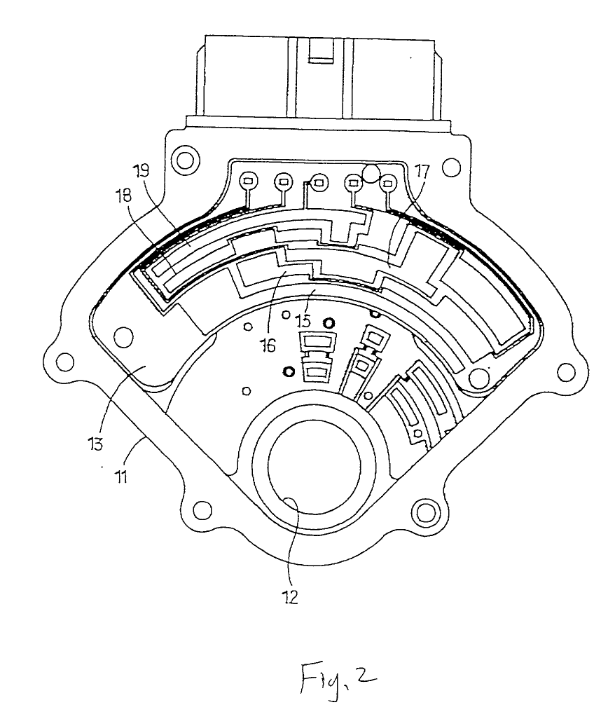

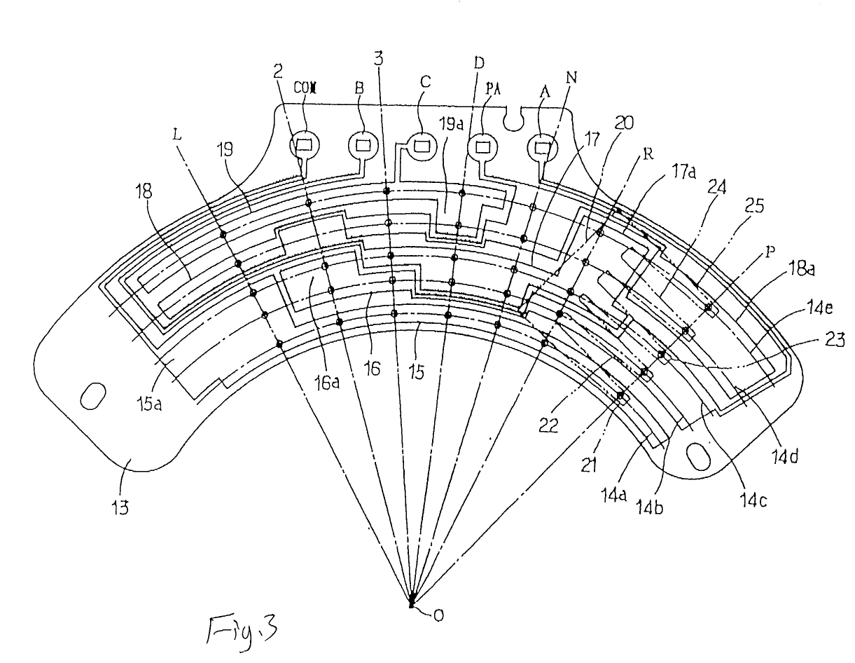

An embodiment of the invention will be described below with reference to FIGS. 1 to 4. First, in FIG. 2, a stator 11 is used in a neutral start switch of an automobile. A hole 12 in which a rotor (not shown) is mounted is formed in the low center of the stator 12. A substrate 13 made of a fan-shaped printed substrate is provided above the hole 12. In this substrate 13, as shown in FIG. 3, five first to fifth lanes 14a to 14e with a circular arc shape using the center of the hole 12 as a center O are set, and five first to fifth fixed contacts 15 to 19 are provided in correspondence with the first to fifth lanes 14a to 14e, and also auxiliary fixed contacts 15a to 19a electrically connected to the first to fifth fixed contacts 15 to 19 are provided as described below.

In FIG. 1, the first to fifth fixed contacts 15 to 19 and the auxiliary fixed contacts 15a to 19a of the substrate 13 are expanded and shown in a model manner for convenience in understanding a principle. In this FIG. 1, open portions show the first to fifth fixed contacts 15 to 19 corresponding to the first to fifth lanes 14a to 14e, and slash portions show the auxiliary fixed contacts 15a to 19a.

The lowest first fixed contact 15 of the first to fifth fixed contacts 15 to 19 in FIG. 1 is a common fixed contact (COM) for power source and the other four second to fifth fixed contacts 16 to 19 are fixed contacts (A, B, C, PA) for signal output to output a signal to a CPU for automobile control. Then, the first to fifth fixed contacts 15 to 19 and the auxiliary fixed contacts 15a to 19a are arranged in a pattern as shown in FIG. 1 in-order to take out a signal for detecting shift positions (P, R, N, D, 3, 2, L) of a shift lever (not shown)

On the other hand, a moving contact member 20 moved along with the shift lever has integrally five contact parts 21 to 25 made of a leaf spring in a manner similar to the related art and is moved among the shift positions (P, R, N, D, 3, 2, L) acting as a working position. The five contact parts 21 to 25 slide along the respectively corresponding first to fifth lanes 14a to 14e and make a connection or disconnection to the first to fifth fixed contacts 15 to 19 and the auxiliary fixed contacts 15a to 19a present on the corresponding first to fifth lanes 14a to 14e with the slide. Portions in which the contact parts 21 to 25 make contact with the first to fifth fixed contacts 15 to 19 and the auxiliary fixed contacts 15a to 19a are indicated by black circles in FIG. 1 and by white circles in FIG. 3. Each of the five contact parts 21 to 25 is elastically urged to the side of the substrate 13, respectively.

In the shift positions (P, R, N, D, 3, 2, L) of the substrate 13, there are blank areas 26 in which corresponding fixed contacts are absent in some lane of the first to fifth lanes 14a to 14e, and it is constructed so that the auxiliary fixed contacts 15a to 19a electrically connected to the fixed contact of other lane are provided in this blank areas in the embodiment.

Specifically, in the “P” position, in the third lane 14c and the fifth lane 14e, the third fixed contact 17 and the fifth fixed contact 19 corresponding to their lanes 14c and 14e are absent. In a blank area 26 in which the third fixed contact 17 is absent, the auxiliary fixed contact 16a connected to the second fixed contact 16 corresponding to the adjacent second lane 14b is provided, and also in a blank area 26 in which the fifth fixed contact 19 is absent, the auxiliary fixed contact 18a connected to the fourth fixed contact 18 corresponding to the adjacent fourth lane 14d is provided.

In the “R” position, in the fourth lane 14d and the fifth lane 14e, the fourth fixed contact 18 and the fifth fixed contact 19 corresponding to their lanes 14d and 14e are absent. In both of blank areas 26 in which these fourth and fifth fixed contacts 18 and 19 are absent, the auxiliary fixed contact 17a connected to the third fixed contact 17 corresponding to the third lane 14c is provided.

In the “N” position, in the second lane 14b and the fifth lane 14e, the second fixed contact 16 and the fifth fixed contact 19 corresponding to their lanes 14b and 14e are absent. In a blank area 26 in which the second fixed contact 16 is absent, the auxiliary fixed contact 17a connected to the third fixed contact 17 corresponding to the adjacent third lane 14c is provided, and also in a blank area 26 in which the fifth fixed contact 19 is absent, the auxiliary fixed contact 18a connected to the fourth fixed contact 18 corresponding to the adjacent fourth lane 14d is provided.

In the “D” position, in the second lane 14b and the fourth lane 114d, the second fixed contact 16 and the fourth fixed contact 18 corresponding to their lanes 14b and 14d are absent. In a blank area 26 in which the second fixed contact 16 is absent, the auxiliary fixed contact 17a connected to the third fixed contact 17 corresponding to the adjacent third lane 14c is provided, and also in a blank area 26 in which the fourth fixed contact 18 is absent, the auxiliary fixed contact 19a connected to the fifth fixed contact 19 corresponding to the adjacent fifth lane 14e is provided.

In the “3” position, in each of the first to fifth lane 14a to 14e, the respectively corresponding first to fifth fixed contacts 15 to 19 are present, and there is no blank area 26 and an auxiliary fixed contact is not provided.

In the “2” position, in the third lane 14c and the fourth lane 14d, the third fixed contact 17 and the fourth fixed contact 18 corresponding to their lanes 14c and 14d are absent. In a blank area 26 in which the third fixed contact 17 is absent, the auxiliary fixed contact 16a connected to the second fixed contact 16 corresponding to the adjacent second lane 14b is . provided, but in this case, in a blank area 26 in which the fourth fixed contact 18 is absent, an auxiliary fixed contact is not provided.

In the “L” position, in the second lane 14b and the third lane 14c, the second fixed contact 16 and the third fixed contact 17 corresponding to their lanes 14b and 14c are absent. In both of blank areas 26 in which these second and third fixed contacts 16 and 17 are absent, the auxiliary fixed contact 15a connected to the first fixed contact 15 corresponding to the first lane 14a is provided.

Also in this case, in order to facilitate processing in the CPU, patterns of the actual first to fifth fixed contacts 15 to 19 and auxiliary fixed contacts 15a to 19a in FIGS. 2 and 3 are designed so that outputs of the first to fifth fixed contacts 15 to 19 change one by one when the moving contact member 20 moves between the shift positions (see FIGS. 2 to 4).

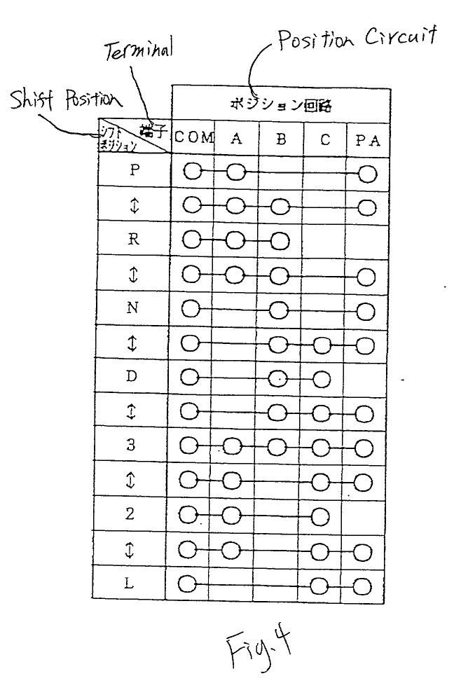

Now in the structure described above, when the moving contact member 20 is moved along with the shift lever in the direction of arrow A in the drawing (the right or left direction), each the contact part 21 to 25 slides along the corresponding lanes 14a to 14e and makes a connection or disconnection to the first to fifth fixed contacts 15 to 19 and the auxiliary fixed contacts 15a to 19a on the corresponding lanes 14a to 14e with the slide. Based on this, a detection signal is outputted from the second to fifth fixed contacts 16 to 19. In the CPU side, based on this detection signal, the shift positions of the shift lever are detected. FIG. 4 shows connection circuits of the first to fifth fixed contacts 15 to 19 (COM, A, B, PA, C) of the shift positions and between each the shift position.

For example, in the “P” position, the lowest contact part 21 in FIG. 1 of the five contact parts 21 to 25 of the moving contact member 20, the second lowest contact part 22, the third lowest contact part 23, the fourth lowest contact part 24, and the highest contact part 25 make contact with the first fixed contact 15, the second fixed contact 16, the auxiliary fixed contact 16a of the second fixed contact 16, the fourth fixed contact 18, and the auxiliary fixed contact 18a of the fourth fixed contact 18, respectively.

At this time, for example, in case that chattering occurs between the second lowest contact part 22 and the second fixed contact 16, a predetermined signal can be obtained as long as the auxiliary fixed contact 16a of the second fixed contact 16 normally makes contact with the contact part 23 corresponding to this. Also similarly, for example, in case that chattering occurs between the fourth lowest contact part 24 and the fourth fixed contact 18, a predetermined signal can be obtained as long as the auxiliary fixed contact 18a of the fourth fixed contact 18 normally makes contact with the contact part 25 corresponding to this. Therefore, in the second fixed contact 16 and the fourth fixed contact 18 to which the auxiliary fixed contacts 16a and 18a are connected, contact portions with the contact parts 22, 23 and 24, 25 increase, so that reliability can be improved by that increase.

Incidentally, in the embodiment described above, a blank area 26 keeps left in the fourth lane 14d in the “2” position, but in this blank area 26, for example, the auxiliary fixed contact 19a connected to the fifth fixed contact 19 may be provided.

The invention is not limited to only the embodiment described above, and can be modified or expanded as follows.

Instead of integrally providing each the contact part 21 to 25 which the moving contact member 20 has, for example, a structure in which separate contact parts 21 to 25 are electrically connected through a connection wire can be formed.

The invention can also be applied to a switch apparatus for other than detection of the shift positions of the shift lever.

As is evident from the above description, according to the invention, it is constructed so that an auxiliary fixed contact electrically connected to the fixed contact of other lane is provided in a blank area which resides in the working positions to which the moving contact member is positioned and in which the fixed contact corresponding to the lane of the plural lanes of the substrate is absent, and thereby in the fixed contact to which the auxiliary fixed contact is connected, contact portions with the contact part increase, so that reliability can be improved by that increase.

What is claimed is:

1. A switch apparatus comprising:
a plurality of fixed contacts provided in correspondence with a plurality of lanes on a substrate; and
a moving contact member slidable along the plurality of lanes having a plurality of contact parts electrically connected and positioned to a plurality of working positions in a movement direction,
wherein each of the contact parts makes a connection or disconnection to the fixed contacts on the corresponding lanes with a movement of the moving contact member, and
wherein an auxiliary fixed contact electrically connected to the fixed contact of other lane is provided in a blank area which resides in the working positions to which the moving contact member is positioned and in which the fixed contact of the corresponding lane is absent.
